(19) United States
(12) Patent Application Publication
(10) Pub. No.: US 2026/0110842 A1
(43) Pub. Date: Apr. 23, 2026

(54) OPTICAL FIBRE POSITIONING DEVICE AND METHOD

(71) Applicant: MICROSOFT TECHNOLOGY LICENSING, LLC, Redmond, WA (US)

(72) Inventors: Andrew Thomas HARKER, Southampton (GB); Simon Michael BAWN, Romsey (GB)

(21) Appl. No.: 19/474,990

(22) PCT Filed: May 30, 2024
(86) PCT No.: PCT/US2024/031707

§ 371 Date: Oct. 13, 2025

(30) Foreign Application Priority Data
Jun. 12, 2023 (LU) LU504476

(51) Int. Cl. G02B 6/25; G02B 6/255

(52) U.S. Cl. CPC G02B 6/25; G02B 6/2555

(57) ABSTRACT

A device comprising a base and a region for receiving an optical fibre holder that is immobilised with respect to the base. The optical fibre holder comprises a clip operable between an open position in which an optical fibre is moveable with respect to the optical fibre holder and a closed position in which the optical fibre is immobilised with respect to the optical fibre holder for longitudinal, rotational, and transverse movement. The device also comprises a clamp rotatably mounted on the base to enable rotation about an axis coincident with a longitudinal axis of a held optical fibre. The clamp is for clamping a held optical fibre and is operable between an unclamped position, and a clamped position in which the optical fibre is immobilised with respect to the base for longitudinal and transverse movement of the optical fibre but rotatable about the longitudinal axis of the optical fibre.

### BACKGROUND

The present invention relates to a device and method for positioning an optical fibre.

The forming of a permanent join between the ends of two portions of optical fibre is a commonplace activity in sectors which utilise optical fibres. Often, the join is formed by fusion splicing, in which the fibres are aligned end-to-end and heated at the end region in order to soften the glass from which the fibres are made. By pressing the ends together, the softened glass is made to fuse so that the fibres are permanently connected when the glass cools and hardens. The join is referred to as a splice. The quality of the splice is an important factor in enabling low loss optical propagation for light travelling from one fibre to the other. Accurate alignment of structural features within the two fibres so as to reduce structural discontinuities at the splice contributes to low loss.

Conventional solid core optical fibres, comprising an annular cladding surrounding a circular core, are relatively simple to align for splicing. The structures have continuous rotational symmetry in transverse cross-section so that transverse alignment of the fibre ends to match the positions of the longitudinal axes of the fibres necessarily aligns the cores and the cladding. However, many optical fibres have a more complex internal structure that lacks continuous rotational symmetry. Some fibres are wholly asymmetric in terms of their transverse structure, so that there is only a single rotational position at which the two fibres are aligned. Other fibres have multi-fold rotational symmetry so alignment occurs at multiple rotational positions. Examples include some polarisation-maintaining fibres which may have two-fold rotational symmetry, and antiresonant hollow core fibres which have a central hollow core surrounded by an inner cladding formed by a ring of N hollow glass capillaries extending along the fibre length which give the fibre an N-fold rotational symmetry and a corresponding N rotational positions at which the structures of two fibres are aligned. Careful structural alignment of the inner claddings of two such fibres at a splice is key to maintaining valuable properties of this type of fibre, which include exceptionally low optical propagation loss when compared to solid core fibres.

Splicing of optical fibres can conveniently be carried out using purpose-built fusion splicers, which receive the ends of two fibres and perform automated alignment of the ends before heating and fusing the glass to form a splice. When designed for use with solid core optical fibres, fusion splicers typically lack any rotational alignment capability.

The embodiments described below are not limited to implementations which solve any or all of the disadvantages of known fibre positioning or fibre splicing apparatus.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Aspects and embodiments are set out in the appended claims.

According to a first aspect of certain embodiments described herein, there is provided a device for positioning an optical fibre, the device comprising: a supporting base; a receiving region on the supporting base, the receiving region configured for receiving an optical fibre holder such that the optical fibre holder is immobilised with respect to the supporting base, the optical fibre holder for holding an optical fibre and comprising a clip operable between an open position in which an optical fibre held in the optical fibre holder is moveable with respect to the optical fibre holder and a closed position in which the held optical fibre is immobilised with respect to the optical fibre holder for longitudinal, rotational and transverse movement of the optical fibre, the supporting base configured to allow operation of the clip between the open position and the closed position when the optical fibre holder is received in the receiving region; and a clamp movably mounted on the supporting base to enable rotation about an axis coincident with a longitudinal axis of an optical fibre held in the optical fibre holder, the clamp configured for clamping an optical fibre held in an optical fibre holder received in the receiving region, and the clamp operable between an open position in which the optical fibre is not clamped with respect to the supporting base, and a closed position in which the optical fibre is clamped and immobilised with respect to the supporting base for longitudinal and transverse movement of the optical fibre but rotatable about the longitudinal axis of the optical fibre.

According to a second aspect of certain embodiments described herein, there is provided a method of positioning an optical fibre, comprising: placing an optical fibre in an optical fibre holder and immobilising the optical fibre with respect to the optical fibre holder for longitudinal, transverse and rotational movement of the optical fibre; placing the optical fibre holder onto a supporting base such that the optical fibre holder is immobilised with respect to the supporting base; clamping the optical fibre with a clamp movable with respect to the supporting base that when closed immobilises the optical fibre with respect to the supporting base for longitudinal and transverse movement of the optical fibre but allows rotation of the optical fibre about the longitudinal axis of the optical fibre; releasing the optical fibre from the optical fibre holder for movement with respect to the optical fibre holder; rotating the optical fibre about its longitudinal axis to achieve a desired rotational position of the optical fibre; immobilising the optical fibre in the desired rotational position with respect to the optical fibre holder; and releasing the optical fibre from the clamp.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, apparatus and methods may be provided in accordance with approaches described herein which includes any one or more of the various features described below as appropriate. Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a simplified transverse cross-sectional view of an example antiresonant hollow core optical fibre, to which methods and apparatus according to the present disclosure are applicable;

FIG. 2 shows a graph of a variation of optical propagation loss with angular position for two butt-coupled antiresonant hollow core fibres;

FIG. 3 shows a simplified schematic perspective view of an example optical fibre holder suitable for use with methods and apparatus of the present disclosure;

FIG. 4 shows a simplified schematic cross-sectional side view of an optical fibre positioning device according to aspects of the present disclosure;

FIG. 5 shows a simplified schematic end view of an optical fibre clamp that may be comprised in an optical fibre positioning device according to aspects of the present disclosure;

FIG. 6 shows a flow chart of a first example method according to aspects of the present disclosure;

FIG. 7 shows a simplified representation of a display screen that may be comprised in an optical fibre positioning device according to aspects of the present disclosure; and

FIG. 8 shows a flow chart of a second example method according to aspects of the present disclosure.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Many optical fibres have an internal structure with discrete features that causes the fibre to lack a continuous rotational symmetry. In such cases, the butt coupling of two portions of fibre placed end-to-end, for example, when forming a splice, can create significant optical propagation loss across the join if the structures are not perfectly aligned in the two fibres. Alignment requires careful rotational adjustment about the longitudinal axis of the fibre into order to bring the structural features into the same orientation, and this can be awkward and time-consuming to achieve.

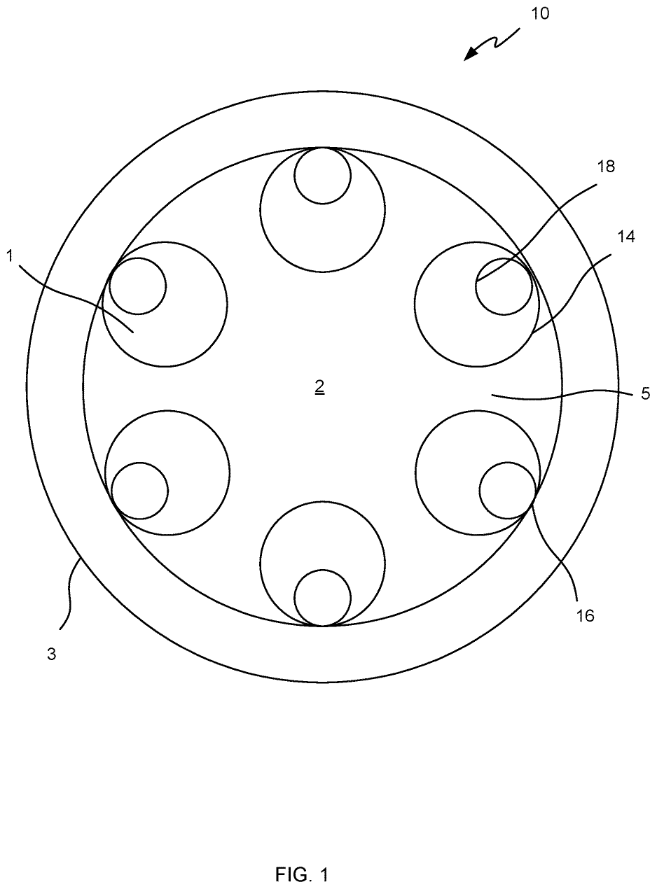

FIG. 1 shows a transverse cross-sectional view of an example of an optical fibre in which this difficulty arises. The fibre is an antiresonant hollow core fibre (ARF) in which light is guided by an antiresonant optical effect. The fibre 10 has an outer tubular cladding or jacket 3. A structured, inner, cladding 1 comprises a plurality of tubular cladding capillaries 14, in this example six capillaries of the same cross-sectional size and shape, which are arranged inside the outer cladding 3 in a single ring, so that the longitudinal axes of each cladding capillary 14 and of the outer cladding 3 are substantially parallel. Each cladding capillary 14 is in contact with (e.g. bonded to) the inner surface of the outer cladding 3 at an azimuthal location 16, such that the cladding capillaries 14 are evenly spaced around the inner circumference of the outer cladding 3, and are also spaced apart from each other by gaps 5 (there is no contact between neighbouring capillaries). In some designs of ARF, the cladding tubes 14 may be positioned in contact with each other (in other words, not spaced apart as in FIG. 1), but spacing to eliminate this contact can improve the fibre's optical performance. The spacing 5 removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity, or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength for which antiresonant optical guiding occurs in the ARF.

In addition, each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs. The nested capillaries are optional, however, and some ARF designs lack them.

More generally, many capillary configurations for the structured cladding of an ARF are possible, and FIG. 1 is merely an example. The capillaries need not be of circular cross-section, and/or may or may not be all of the same size and/or shape. The number of capillaries surrounding the core may be for example, four, five, six, seven, eight, nine or ten, although other numbers are not excluded.

Regardless of the precise details of the structure, it will be apparent from FIG. 1 that an ARF lacks continuous circular symmetry, so that care should be taken when coupling portions of such fibre to make a splice. In the FIG. 1 example, the six nested cladding capillary groups are of equal size and shape, and so give a six-fold rotational symmetry so that there are only six rotational positions in which two portions of fibre will be precisely structurally aligned. At intermediate positions, the cladding capillaries will be misaligned, giving structural discontinuities at a join so that propagating light will experience loss and the overall performance of the spliced fibre will be negatively impacted.

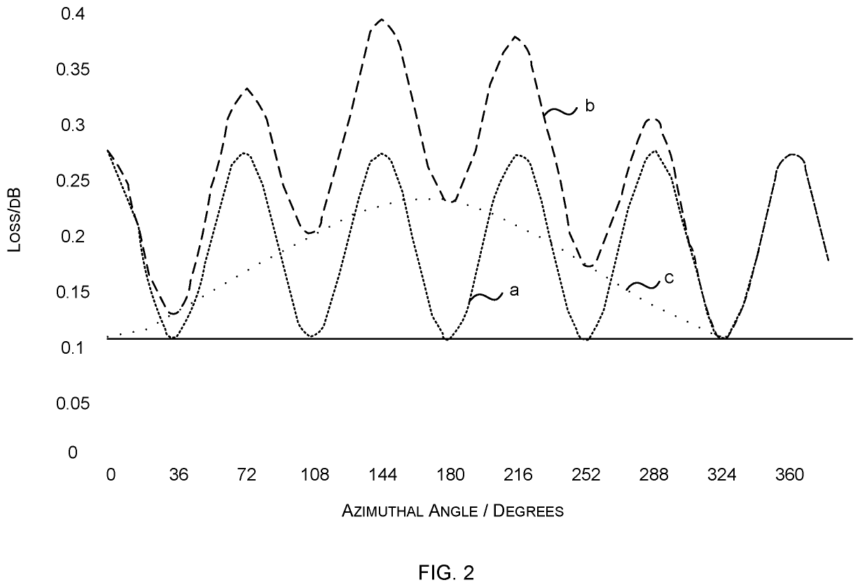

FIG. 2 shows a graph of optical loss across a butt-coupled join (a join in which the end faces of two optical fibres are butted up against one another) between two portions of ARF fibre, in this example, a fibre with five cladding capillaries, and a corresponding five-fold rotational symmetry, in contrast to the six-fold symmetry of the FIG. 1 example. The graph shows the variation of optical loss (in decibels) with azimuthal or rotational angle about the longitudinal axis of one of the fibre portions relative to the other fibre portion. The line “a” shows the modelled optical loss expected for a perfectly structured optical fibre with no defects, and shows the loss over a full 360° rotation of one fibre portion relative to the other. Five troughs of minimum loss can be seen at regular intervals, corresponding to the capillary structure coming into repeated alignment as the fibre is rotated. At intermediate angles, the capillary structure becomes increasingly misaligned, giving a peak loss which decreases as the structure approaches the next aligned position. The line “b” shows this variation in loss measured from real fibres, where the periodic loss is superposed on a more gradual loss curve “c” arising from an eccentricity in the measurement apparatus and fibre structure that causes additional lack of alignment of the capillary structures.

From this it can be appreciated that the ability to adjust the rotational position of non-rotationally symmetric optical fibres before coupling and splicing is valuable, in order to reduce splicing loss. The present disclosure describes an apparatus and method by which such rotational positioning can be carried out. The described apparatus and method are applicable to all optical fibres, with particular relevance to the ARF type of optical fibre discussed above, and other optical fibres specifically designed with a non-circularly symmetric cross-sectional structure. For circularly symmetric optical fibres, the approach could still be useful for enabling an inspection and possible rotational orientation, for example, to accommodate any minor structural asymmetries arising from fabrication defects.

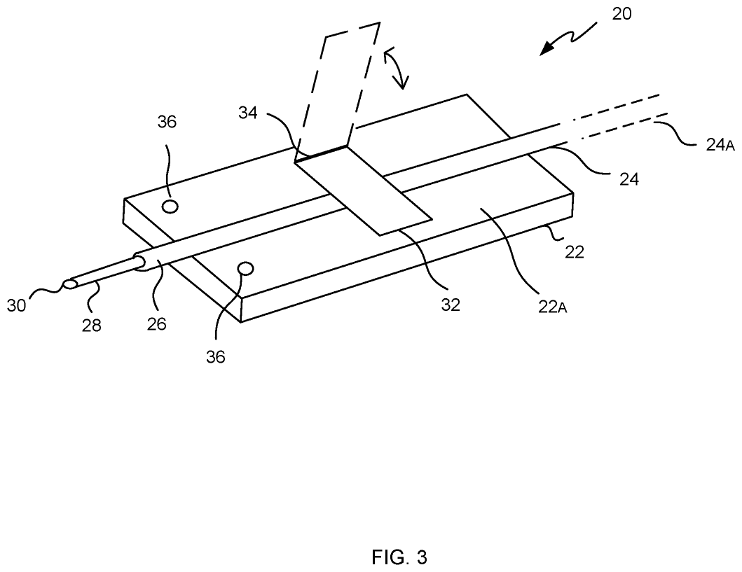

FIG. 3 shows a simplified perspective view of a device for holding an optical fibre, which will be referred to herein as an optical fibre holder. Such optical fibre holders may be used, for example, for holding optical fibres in a fixed position and orientation during processes such as cleaving. The optical fibre holder 20 comprises, in this example, a relatively thin flat plate 22 with an upper surface 22a on which an optical fibre 24 to be held in placed or laid flat, with its longitudinal axis parallel to the upper surface 22a. The plate 22 may comprise a straight groove (not shown) in its upper surface 22a into which the optical fibre 24 can be laid to aid with placement, although this is not essential. The optical fibre 24 is placed on the plate 22 with one of its ends 26 protruding a short distance beyond the end of the plate 22; this can be considered to be the working end of the optical fibre 24, that is, the end which is to be processed. Typically, a portion of the outer coating of the optical fibre 24 immediately adjacent to the working end will be removed, providing an end portion 28 of uncoated fibre with exposed cladding and terminating in an end face or end facet 30 of the optical fibre 24. The opposite end 24a of the optical fibre 24 is a free end, and may extend to a significant length beyond the optical fibre holder 20 depending on the intended use of the optical fibre 24.

The optical fibre holder 20 comprises a clip 32 for securing the optical fibre 24 to the optical fibre holder 20. In this example, the clip 32 is a small, substantially straight element, for example, made from metal, which is mounted to the upper surface 22a (fibre holding surface) of the plate 22 at one end of the clip 32 by a hinged joint 34, which allows the clip 32 to move between a first position (dotted line) in which the clip 32 is away from the upper surface 22a and a second position (solid line) in which the clip 32 lies against the upper surface 22a. In the first position, the clip 32 is open, and the upper surface 22a is exposed so that the optical fibre 24 can be placed upon it. Once the optical fibre 24 is positioned, the clip 32 can be moved into the second position, in which it is closed, and in which the clip 32 overlays the optical fibre 24 so that the optical fibre 24 is sandwiched between an underside of the clip 32 and the upper surface 22a of the plate 22 so that the optical fibre 24 is secured against the upper surface 22a (within the groove, if present). The clip 32 closes tightly so as to grip or press on the optical fibre 24. In this way, the optical fibre 24 is immobilised with respect to the optical fibre holder 20 so that the optical fibre 24 cannot move (or not move to any appreciable degree) in any direction, namely longitudinally (along the length direction of the optical fibre), transversely (sideways, or perpendicularly to the length of the fibre), and rotationally (rotation about the longitudinal axis of the optical fibre). The clip 32 might be spring-loaded or engaged by a catch or a magnet to achieve this secure gripping of the optical fibre 24, for example. The depicted configuration of the clip 32 is an example only, and any configuration can be used which provides a clip or similar element which is operable (typically operable manually by a user, but automatic arrangements are not excluded) between an open position in which an optical fibre in the optical fibre holder 20 can be moved relative to the holder 20 (for example, placed into the holder, removed from the holder, or positionally adjusted relative to the holder), and a closed position in which an optical fibre in the holder 20 is securely held so that it is immobilised, or made substantially immovable relative to the holder 20.

A purpose of such an optical fibre holder is to enable the location of an optical fibre in an appropriate position within a fibre processing apparatus such as a fibre cleaver or a fibre fusion splicer, where it is key that the end of a fibre is positioned correctly with respect to parts of the apparatus and/or another fibre to allow proper implementation of the relevant process. Accordingly, the optical fibre holder 20 may have one or more locator elements that allow it to be fixed into position relative to and within other apparatus. The locator elements may comprise one or more through-holes 36 that extend wholly or partially through the plate 22 from its underside for engagement with protruding pins in or on the fibre processing apparatus. In other examples, the locator elements may comprise one or more magnets within the plate 22 that interact with and attract magnets in the fibre processing apparatus to secure the optical fibre holder 20 into the correct position. In other examples, the optical fibre holder 20 may have no dedicated locator elements, but the fibre processing apparatus may have a recess into which the plate 22 closely fits, or the apparatus may include one or more catches or latches which engage with the plate 22 to hold it firmly. Other alternatives will be readily apparent.

An example of the use of such an optical fibre holder is in the cleaving and subsequent splicing of an optical fibre. For cleaving, an optical fibre with its coating stripped at the working end may be secured into an optical fibre holder, which is in turn placed in a fibre cleaver which is operated to cleave the working end of the fibre to produce an end facet suitable for splicing. The end facet then has a fixed location relative to the optical fibre holder owing to the immobilisation of the fibre in the holder. The optical fibre holder, holding the cleaved fibre, is then removed from the fibre cleaver, and can be placed directly into a compatible splicer (compatible with both the fibre cleaver and the optical fibre holder) in which the optical fibre holder thereby necessarily locates the end facet in the correct place for operation of the splicer. The process can be repeated with a second optical fibre, where the splicer is configured to receive a second optical fibre holder holding a cleaved optical fibre such that the two end facets are in approximately correct positions for operation of the splicer.

Typically, a splicer or splicing apparatus may include automated alignment of the two end facets relative to one another. This may involve observation or detection of the end facets with cameras, and the operation of alignment software that controls small movements of the optical fibre holders to properly place the fibres for splicing, in response to the observed positions. However, such movement is generally only enabled in the longitudinal and transverse directions, and no rotation of the fibres is included. In rare cases, splicing apparatus may additionally provide rotational movement, but such apparatus is slow, costly, delicate and bulky and therefore largely suitable only for interior laboratory and clean-room use rather than use in the field. Often, however, fibre splicing needs to be performed in the field such as during the installation of optical fibre communications networks. Applications of this type require equipment which is preferably robust, portable, simple, and quick to operate (e.g. since there may be 100 or more optical fibres in any cable). While simple fusion splicers are available that meet these criteria, the ability to rotationally align fibres is absent, so such splicers are not suitable for achieving low loss splices in fibre types such as antiresonant hollow core optical fibres. Also, apparatus that does provide rotational movement typically involves rotation of the optical fibre holder rather than the optical fibre itself.

Accordingly, it is proposed herein to introduce an optical fibre positioning device configured to enable rotational positioning of an optical fibre prior to placement of the optical fibre into a splicing apparatus (or other fibre processing apparatus), and subsequent to cleaving of the fibre in a cleaving apparatus if this is required. The device allows rotational positioning of the optical fibre relative to the optical fibre holder while preserving the longitudinal and transverse positions of the fibre relative to the optical fibre holder. This means that once an optical fibre held in an optical fibre holder has been cleaved, the optical fibre is rotationally oriented relative to the optical fibre holder before it is placed with the optical fibre holder into a fibre splicer with the location of the end facet established by the cleaving maintained so that the fibre is correctly located within the splicer and additionally correctly oriented in the rotational dimension for rotational alignment with another optical fibre to which it is to be spliced. By enabling the rotational orientation to be performed relative to the optical fibre holder and prior to, and separate from, the splicing operation, the rotational orientation of a second fibre can be performed in parallel with the splicing of a first fibre. This increases the overall speed of the combined operation, e.g. to repair a cable break where, as described above, the cable may comprise a large number of fibres.

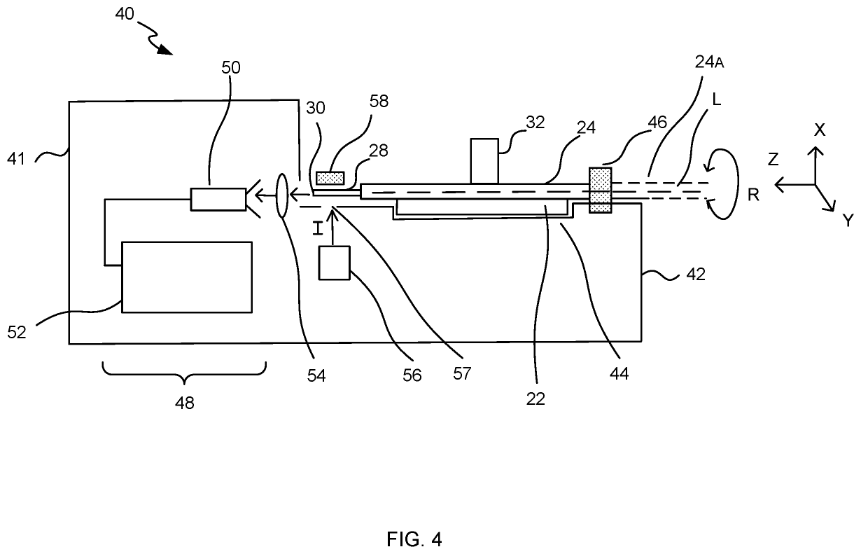

FIG. 4 shows a simplified schematic cross-sectional side view of an example optical fibre positioning device according to an embodiment of the present disclosure. The device 40 enables rotation of an optical fibre about the longitudinal axis of the optical fibre and subsequent fixing of the optical fibre into a desired rotational orientation while the longitudinal and translation positions of the optical fibre are maintained during the rotation and fixed along within the desired rotational orientation. This is achieved by receipt of the optical fibre with a fixed position relative to an optical fibre holder such that the optical fibre holder becomes fixed relative to the device, additional fixing of the optical fibre position relative to the device in the transverse and longitudinal directions only, release of the optical fibre from the optical fibre holder so that the fibre can move relative to the optical fibre holder and the device in the rotational direction only, adjustment of the rotational position, refixing of the optical fibre at the desired rotational orientation to the optical fibre holder so that relative to the optical fibre holder the optical fibre has the new rotational orientation and the previous transverse and longitudinal positions, and release of the optical fibre from the device.

The device 40 comprises a supporting base 42 to which an optical fibre held in an optical fibre holder can be mounted to perform rotational alignment of the optical fibre. The supporting base 42 has a receiving region 44 for receiving an optical fibre holder 20, such as the holder described with reference to FIG. 3. The receiving region 44 secures the optical fibre holder 20 relative to and with respect to the supporting base 42, for example, by any of the ways described for the FIG. 3 example, such as magnets, cooperating pins and through-holes, latches, or a correspondingly sized recess (as depicted). When an optical fibre holder 20 is present in the receiving region 44, an optical fibre 24 held in the optical fibre holder 20 and secured in the optical fibre holder 20 by the clip 32 is therefore also immobilised with respect to the supporting base 42. The receiving region 44 is configured such that the clip 32 of the optical fibre holder 20 can be moved between its closed position and its open position (as depicted) while the optical fibre holder 20 is in the receiving region. In some examples this is achieved by the optical fibre holder 20 being received in the receiving region 44 with its fibre holding surface and, therefore, its clip 32 facing outwardly (upwardly as depicted) and exposed so that a user can access the clip 32 to move the clip 32 when the optical fibre holder 20 is in the receiving region 44. However, other arrangements, such as the optical fibre holder being covered and a clip operating mechanism for engaging with, releasing, and closing the clip, are not excluded.

The optical fibre 24 held in the optical fibre holder 20, which is received in the receiving region, has its longitudinal axis L arranged along a direction Z (substantially parallel to the supporting base 42). Immobilisation of the optical fibre holder 20 and hence the optical fibre 24 when the clip 32 is closed fixes the optical fibre 24 in position relative to the supporting base 42, preventing longitudinal movement along the Z direction, transverse movement in an XY plane orthogonal to the Z direction and the longitudinal axis L of the optical fibre 24, and rotational movement R about the longitudinal axis L of the optical fibre 24.

The device 40 also comprises a clamp 46, which is mounted on the supporting base at a position spaced from the receiving region 44 along the Z direction. The clamp 46, when in a closed position, holds and grips an optical fibre, and its position in this example enables it to grip the optical fibre 24 held in the optical fibre holder 20 at a location along the free end 24a of the optical fibre 24 where the optical fibre 24 extends beyond the optical fibre holder 20. The clamp 46, shown schematically only in FIG. 4, is rotationally mounted on the supporting base 42 so that the clamp 46 can be rotated relative to the supporting base 42, the optical fibre 24 held in the clamp 46 being rotated with the clamp 46. The mounting of the clamp 46 on the supporting base 42 is arranged such that movement of the held optical fibre 20 is rotational movement about the Z direction, in other words, rotation R of the optical fibre 24 about its longitudinal axis L.

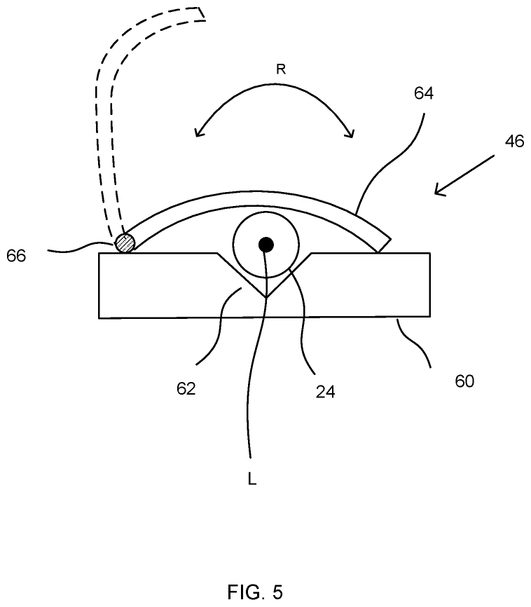

FIG. 5 shows a simplified schematic end view (so along the Z direction shown in FIG. 4) of an example of a clamp 46. The clamp 46 is rotationally mounted on the supporting base of the device (not shown here) and comprises, in this example, a lower portion 60 with a surface for receiving the optical fibre 24, in this example via an optional groove 62 in the surface of the lower portion 60, and an upper portion 64 facing the surface of the lower portion 60 which is hingedly mounted to the lower portion 60 at a hinge 66, rotating joint or similar arrangement. The upper portion 64 is movable via the hinge 66 between an open position (dashed line) in which the surface of the lower portion 60 is accessible for receiving the optical fibre 24, and a closed position (solid line) in which the upper portion 64 engages against the optical fibre 24 and holds or clamps it against the surface of the lower portion 60 to inhibit movement of the optical fibre 24 within the clamp 46. When the clamp 46 is closed, the optical fibre 24 is immobilised for longitudinal, transverse, and rotational movement relative to the clamp 46. However, the mounting of the clamp 46 on the supporting base of the device means that the clamped optical fibre 24 is immobilised for longitudinal and transverse movement relative to the supporting base, but rotational movement R of the optical fibre 24 about its longitudinal axis L relative to the supporting base occurs together with rotation of the clamp 46 about its rotational mounting on the supporting base. Note that this example of the clamp 46 is illustrative only and is in no way limiting; any releasable way of fixedly gripping an optical fibre can be used.

In FIG. 4, the clamp 46 is located so as to clamp the fibre 24 at its free end 24a; i.e. at a part of the fibre 24 extending beyond the optical fibre holder 20 opposite to the working end 28 of the fibre 24. This is a practical arrangement since the working end 28 of the fibre may typically not extend very far beyond the optical fibre holder 20, particularly if the working end 28 has already been cleaved so that the end face 30 of the fibre 24 is a cleaved end facet ready for splicing. Hence there is little room available to clamp the fibre 24 at the working end 28. However, this arrangement is not limiting, and the clamp 46 may instead clamp the fibre 24 at its working end 28, or two clamps 46 may be provided, to clamp the fibre 24 at both its free end 24a and its working end 28. Where two clamps are provided, a first clamp 46 at its free end 24a and a second clamp 58 at its working end 28, the second clamp may be different from the first clamp 46. In various examples, the second clamp, that is positioned at the working end 28 of the fibre 24, is not rotatably mounted. The second clamp, when in an open position, does not constrain the position of the fibre 24 and, when in a closed position, provides an aperture that is sized to receive the working end 28 of the fibre so as to enable rotational movement of the fibre 24 within the aperture but transverse movement in the XY plane.

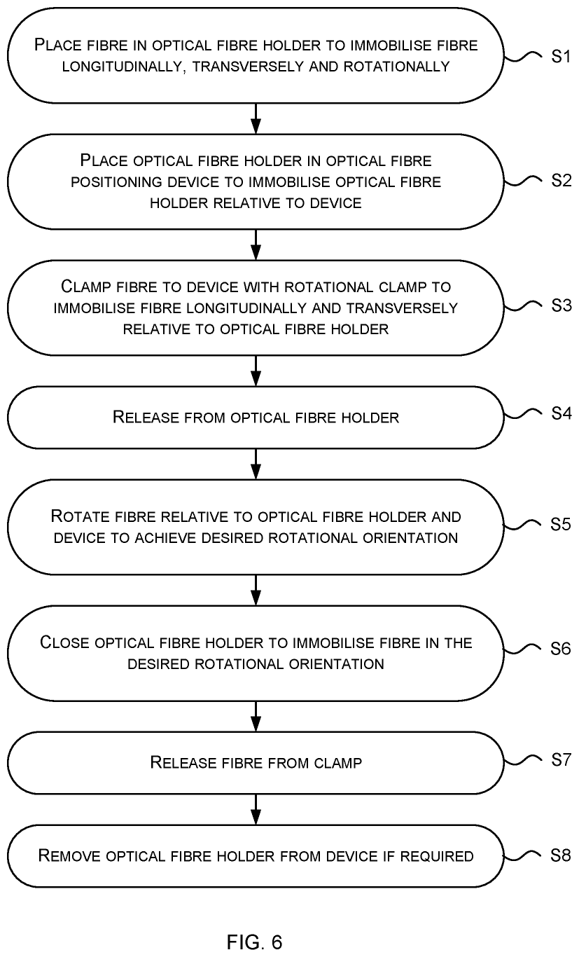

FIG. 6 shows a flow chart of steps in an example method for positioning an optical fibre according to an embodiment, for example by using the optical fibre holder of the FIG. 3 example and the device of the FIG. 4 example. In a first step S1, an optical fibre with a working end and a free end is placed in an optical fibre holder, and immobilised with respect to the optical fibre holder so that longitudinal, transverse, and rotational movement of the fibre is inhibited, for example, by restraining the fibre with a clip of the optical fibre holder as in FIG. 3. In a second step S2, the optical fibre holder is placed in an optical fibre positioning device, such as by placing the optical fibre holder in the receiving region of the supporting base of the device of FIG. 4. In this way, the optical fibre holder, and therefore also the held fibre therein, are immobilised relative to the device. In a third step S3, the optical fibre is clamped to the device using a rotationally mounted clamp on the device, such as the clamp of FIGS. 4 and 5, so that the fibre is additionally immobilised relative to the device and therefore also relative to the optical fibre holder via the clamp, as regards longitudinal and transverse movement. In a fourth step S4, the optical fibre is released from the optical fibre holder, such as by opening the clip of the holder of FIG. 3. Now the fibre has a fixed position relative to the optical fibre holder and the device in the longitudinal and transverse directions, owing to being clamped in the clamp, but can move rotationally relative to the device and the optical fibre holder because the clamp is free to rotate relative to the device. This configuration is shown in FIG. 4, in which the clip of the optical fibre holder is open, but the fibre is held in the clamp. In a fifth step S5, the optical fibre is rotated about its longitudinal axis relative to the optical fibre holder, and hence also to the device, in order to position the fibre in a desired rotational orientation. During the rotation, the longitudinal and transverse positions of the fibre are maintained, owing to the fibre being retained in the clamp. Conveniently, the rotation can be implemented by rotation of the clamp, which can be accessible for manual manipulation by a user, for example, or may be driven by a motor controllable by a user or by software. Alternatively, the fibre might be rotated directly, carrying the clamp with it, by the user holding the fibre and twisting it, for example. Once the desired rotational position is achieved, the method proceeds to a sixth step S6, in which the optical fibre is again immobilised for all movement directions relative to the optical fibre holder and the device, for example, by closing the clip of the optical fibre holder of FIG. 3. This secures the fibre in the required rotational orientation with the existing longitudinal and transverse positions preserved. In a seventh step S7, the fibre is released from the clamp, so that it is no longer directly fixed or immobilised relative to the device. In an eighth step S8, the optical fibre holder, with the properly oriented and positioned optical fibre held therein, may be removed from the device if and when required, for example, to place the fibre as held by the optical fibre holder into a fibre processing apparatus such as a fibre splicer.

In order to enable placement of the optical fibre into the desired rotational orientation, it is practical to use or provide some observation apparatus that allows the transverse cross-section of the fibre to be viewed. In this way, direct visual inspection of the internal structure of the optical fibre can be made so that its rotational orientation can be ascertained. This visual inspection might be made by a user, with manual adjustment of the rotational position of the fibre made in response, or a view of the fibre might be processed by a computer processor configured to generate and sends control signals to an automated rotatable clamp to produce the rotational adjustment. The observation apparatus might be separate from the optical fibre positioning device and used in conjunction with it, for example, a fibre inspection or viewing apparatus usable for general fibre viewing applications. In this case, the apparatus might comprise a camera viewing the end of the optical fibre and sending captured images of the fibre end to a display screen where it can be viewed by a user or to a processor for automated control. A non-camera-based approach might be used, such as a microscope or similar arrangement of viewing and magnifying lenses and mirrors. In some examples, the observation apparatus is incorporated into the optical fibre positioning device, which is advantageously convenient for the user. This can be done without significant increase in size of the device, so that the device can remain compact and practical for use in the field, for example.

Returning to the FIG. 4 example, an example observation apparatus is shown. Viewing the end of the fibre means that the longitudinally axial rotational position of an optical fibre can be assessed,. This can most simply be done by viewing the cross-section of the fibre end, in other words, observing an “end-on” view of the fibre end, looking along its longitudinal axis direction. Observation of a side view of the fibre end is also feasible, but requires more interpretation of the view to determine the orientation of the fibre. End-on observation is, therefore, more user-friendly. To implement end-on observation, the device of FIG. 4 includes observation apparatus 48 that comprises a camera 50, which images the working end 28 of the optical fibre 24 in the end-on view, so the optical axis of the camera 50 is directed along, or at least parallel to, the longitudinal axis of the fibre 24, that is, along the Z direction. For protection, the camera may be located inside a housing 41 of the device 40, adjacent to or above the supporting base 42, with a viewing window or aperture provided in a wall of the housing 41 through which the camera observes the end face 30 of the fibre. Recalling that the end face 30 of the fibre 24 may have a known position relative to the optical fibre holder 22 if, for example, the working end 28 of the fibre 24 has been cleaved in a compatible cleaving apparatus after being secured to the optical fibre holder 22, the end face 30 may have a pre-defined spacing from the camera 50 so that the camera 50 may be set up so that the end face 30, in the end-on view, is in focus for the camera. However, to account for optical fibres that may not have been cleaved in this way, and/or minor errors in cleaving, an adjustable focusing lens 54 may be provided between the camera 50 and the fibre end 30 so that the focus may be adjusted or corrected by the user (or automated if computer control of all or part of the device is implemented) so that the end-on view of the end face 30 is focussed onto the image capture elements or elements in the camera 50. One or more other lenses or mirrors (not shown) may be included to capture incoming light and focus and/or direct it to the camera. The camera may capture still images, or more conveniently, a continuous image so that rotational movement of the optical fibre can be followed in real time.

The camera 50 outputs image data representing images of the end face 30. For viewing by a user, the image data can be sent to an external monitor connected to the camera. More conveniently, to better enable use of the device in the field, the device or the supporting base thereof can include an integral display screen 52 connected to the camera to receive the output image data and display an image of the current view of the end face of the optical fibre to a user, as shown in FIG. 4. For manual adjustment of the rotational position of the optical fibre, the user can therefore observe the end-on view of the optical fibre 28 on the display screen 52, and rotate the fibre until the required rotational orientation is achieved while viewing the image in real time.

The end-on camera-based observation apparatus 48, as shown in FIG. 4, does not involve any moving mirrors (e.g. as would be required if the camera was not aligned with the longitudinal axis of the fibre). This improves the durability and reliability of the device 40 and makes it more suitable for use in the field.

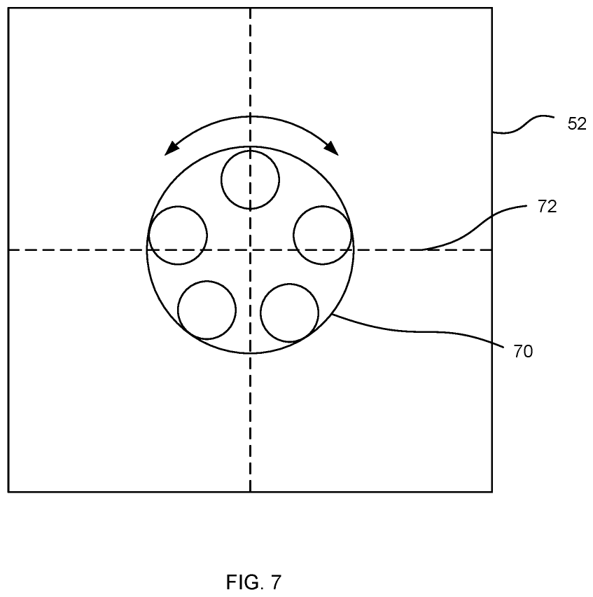

FIG. 7 shows a schematic view of an example of the display screen of the FIG. 4 example device. The screen 52 shows an image 70 of the end-on view of the optical fibre 24. In this example, the fibre 24 is an ARF with five spaced apart cladding capillaries. The display screen may also display one or more grid lines or cross hairs 72 to aid positioning of the fibre 24; the user can rotate the fibre to align the image relative to one or more of the grid lines and designate the corresponding fibre position as the desired rotational position. For example, if two fibres are being rotationally oriented in succession to be then placed in a fibre splicing apparatus to be spliced together, the fibres can be rotated until each has a capillary in the same location, as indicated by the displayed images. FIG. 7 shows the fibre positioned with a capillary located at the “12 o'clock” position, and bisected by a vertical grid line passing through the central longitudinal axis of the fibre. A second fibre can be similarly aligned, so that both have the same rotational orientation when removed from the device and placed in a splicing apparatus, held on their individual optical fibre holders.

Depending on the circumstances of use of the device, the fibre end may be sufficiently well illuminated by environmental lighting that a quality image is captured by the camera and shown on the display. To address circumstances where insufficient light is available, the device may additionally include a light source which illuminates the working end of the optical fibre for better imaging. In an example, the light source may comprise one or more light-emitting diodes or bulbs which shed ambient light onto the working end of the optical fibre. Light will be reflected from the fibre end into the camera, in the usual manner of lighting a photographic subject.

However, illumination and imaging of the fibre end can be improved by the detection of light emitted from the fibre end. In order to enable this, the light source can be arranged to direct light onto the side of the optical fibre. FIG. 4 shows a light source 56 operable in this way. The light source 56 can be located at any side-on position to the optical fibre, but for safety and protection of the light source 56 it may be located as shown in FIG. 4, being set into or below the surface of the supporting base 42 on which the fibre 24 is received, and positioned to direct illuminating light towards the side of the fibre (in an upward direction in the depicted example), through an aperture or transparent window 57 if appropriate, depending on the location of the light source 56. The light I emitted from the light source 56 is incident on the side of the fibre 24. Some of the incident light I will couple into the cladding of the fibre 54, and additionally the core, and will propagate along the fibre 54 to be emitted from the end face 30 towards the camera 50. For some fibre types the coating will be of a form that transmits light into the cladding so that the illuminating light source 56 can be located at any point along the length of the fibre where it overlies the supporting base. For other fibre types, the coating may be opaque or partially opaque such that it absorbs some of incident light so the light source 56 should be located to direct light onto the side of the fibre 24 near to the end face 30 where the coating will likely have been removed from the fibre 24. Furthermore, by positioning the light source 56 close to the end face 30 of the fibre (irrespective of the coating type), the illumination of the internal structure of the fibre (e.g. capillaries 14, 18) is increased relative to the cladding (e.g. cladding 3). This results in the structure of the fibre end being lit well and improves visibility of the internal fibre structure to enable accurate rotational positioning. This arrangement is shown in FIG. 4.

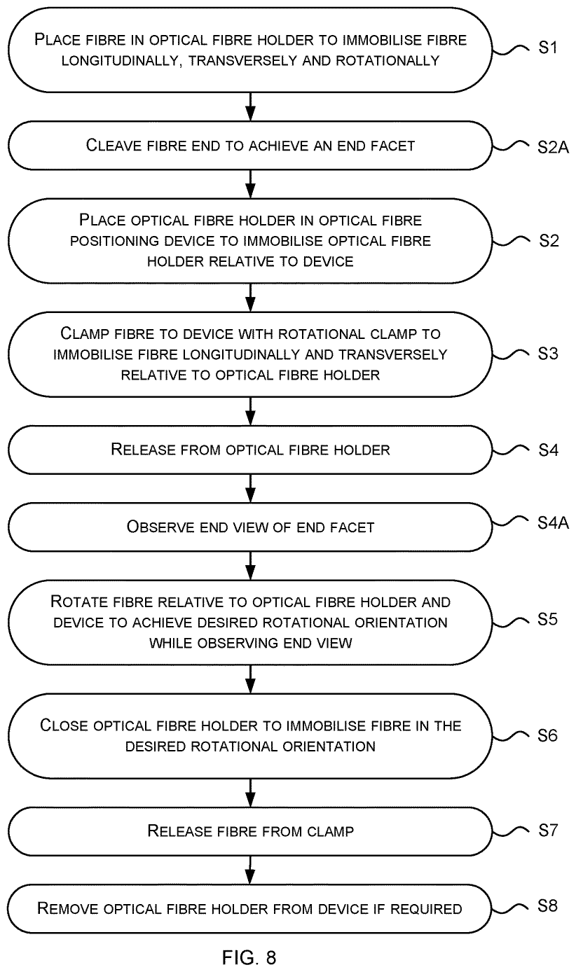

FIG. 8 shows a flow chart of another example method of rotationally positioning an optical fibre. Many of the steps are the same as the correspondingly numbered steps in the FIG. 6 method and will not be described further. An additional optional step S1a is added after the first step S1, in which the working end of the optical fibre is cleaved to produce a cleaved end facet after the fibre has been placed in the optical fibre holder in step S1. To achieve this, the optical fibre holder is selected to be compatible with both the cleaving apparatus to be used in step S1a, and the optical fibre positioning device in which the optical fibre holder is to be placed in step S2.

The method also includes an additional optional step S4a, in which the end facet (or end face in the case of the cleaving step S1a not having been performed) of the optical fibre is observed in end view so that the cross-sectional structure of the fibre can be seen, using any of the observation approaches outlined above. Rotation of the fibre into the required rotational position in step S5 can then be performed while the end view of the fibre is observed or monitored, so that it can be readily determined when the desired rotational position for the fibre has been achieved.

The rotatable mounting of the clamp on the supporting base of the device may provide continuous rotation over a full 360 degrees or more, so that an optical fibre can be placed into any rotational orientation from any initial orientation. This can be enabled by a clamp rotation of 360 degrees rotation in a single direction, or by a clamp rotation of 180 degrees from an initial orientation in both of two opposite directions (rotation of ±180 degrees). However, for many optical fibres, this range of rotation will not be necessary, and the rotation need only accommodate the foldedness of the rotational symmetry of the expected fibre types, since for most fibre designs there will be more than one rotational position in which the internal structure is aligned with a desired position. Accordingly, the clamp can be configured to provide a limited range of rotation only, limited to less than 360 degrees. For a fibre structure with two-fold rotational symmetry, such as a fibre with polarisation-maintaining elements incorporated within it (such fibre may or may not also be an ARF), a range of rotation up to 180 degrees only (the rotation is limited to not more than 180 degrees) will be sufficient. Practically, though, a little extra rotation may be provided to allow for fabrication defects and slightly misplaced elements, for example rotation limited to not more than 190 degrees or not more than 200 degrees. For ARF designs in which all cladding capillaries have the same configuration, much smaller ranges can be adequate. For example, an ARF with six cladding capillaries of the same design (as in the FIG. 1 example) can be oriented by rotating up to sixty degrees (360 degrees divided by six) and an ARF with five cladding capillaries can be oriented by rotating up to 72 degrees (360 degrees divided by five). To allow for errors, rotational ranges limited to up to 70 degrees and 80 degrees respectively could be enabled, for example. Rotation in both directions provides more flexibility, so these various examples might be implemented via rotational ranges of up to ±95 degrees, ±100 degrees, ±35 degrees and ±40 degrees. Limited rotational capability of the clamp may be more straightforward to implement than complete rotation to any angular position, so the device can be simplified without comprising operational performance for many designs of optical fibre for which the proposed devices and methods are most applicable. Other angular ranges of rotation than the above examples are not excluded, and be selected according to expected uses of the device.

Devices as described herein provide an intermediate apparatus useable in conjunction with existing fibre processing apparatus for fibre splicing, fibre cleaving and other processes in order to improve the results obtainable from such apparatus, such as reduced loss and improved optical performance of spliced fibres. The device can be implemented with only a small number of relatively simple components and elements, so can be made compact and robust, and therefore convenient and fast to use in the field, and also inexpensive.

While a dedicated, single-purpose rotational positioning device (such as the FIG. 4 example, which is configured to perform fibre rotational positioning, and no other fibre processing application) is beneficial as an adjunct to existing fibre processing apparatus that does not enable rotational positioning, the principles and configurations described herein may additionally be implemented as an additional feature in a fibre processing apparatus configured for other processing applications such as cleaving or splicing. For example, a fibre cleaving apparatus may be operable to achieve cleaving of a fibre, with rotational positioning of the fibre performed within the cleaving apparatus before or after the cleaving. In another example, a fibre splicing apparatus, such as a fusion splicer, may be operable to receive two cleaved fibres and carry out rotational positioning on one or both fibre before the splicing is performed.

Alternatively or in addition to the other examples described herein, examples include any combination of the following features.

A first further example provides a device for positioning an optical fibre, the device comprising: a supporting base; a receiving region on the supporting base, the receiving region configured for receiving an optical fibre holder such that the optical fibre holder is immobilised with respect to the supporting base, the optical fibre holder for holding an optical fibre and comprising a clip operable between an open position in which an optical fibre held in the optical fibre holder is moveable with respect to the optical fibre holder and a closed position in which the held optical fibre is immobilised with respect to the optical fibre holder for longitudinal, rotational and transverse movement of the optical fibre, the supporting base configured to allow operation of the clip between the open position and the closed position when the optical fibre holder is received in the receiving region; and a clamp movably mounted on the supporting base to enable rotation about an axis coincident with a longitudinal axis of an optical fibre held in the optical fibre holder, the clamp configured for clamping an optical fibre held in an optical fibre holder received in the receiving region, and the clamp operable between an open position in which the optical fibre is not clamped with respect to the supporting base, and a closed position in which the optical fibre is clamped and immobilised with respect to the supporting base for longitudinal and transverse movement of the optical fibre but rotatable about the longitudinal axis of the optical fibre.

The clamp may be configured to be rotatable with respect to the supporting base in order to rotate the optical fibre about the longitudinal axis of the optical fibre.

The clamp may be manually rotatable.

The clamp may be configured to rotate the optical fibre over a range limited to less than 360 degrees.

The clamp may be configured to rotate the optical fibre over a range limited to not more than 200 degrees.

The device may further comprise an observation apparatus mounted on the supporting base and configured to provide an end-on view of an end of an optical fibre held in the optical fibre holder and clamped by the clamp.

The observation apparatus may comprise a camera operable to capture images of the end-on view of the end of the optical fibre.

The observation apparatus may further comprise an adjustable lens operable to focus the end-on view of the end of the optical fibre onto an image capture element of the camera.

The device may further comprise a display screen configured to display images of the end-on view of the end of the optical fibre captured by the camera.

The device may further comprise a light source operable to illuminate the end of the optical fibre viewable by the observation apparatus.

The light source may be arranged to direct light onto a side of the optical fibre that said light is coupled into the optical fibre through the side of the optical fibre for propagation along the optical fibre and emission from the end of the optical fibre towards the observation apparatus. The light source may be arranged to direct the light onto the side of the optical fibre proximate to an end facet (or end face) of the optical fibre.

The light source may comprise one or more light-emitting diodes.

The device may be configured only for positioning optical fibres.

The light source maybe positioned to direct light onto the side of the optical fibre close to the end of the optical fibre.

The device may be further configured for processing optical fibres in addition to positioning optical fibres.

The device may be configured for cleaving or splicing optical fibres in addition to positioning optical fibres.

A second further example provides a method of positioning an optical fibre, comprising: placing an optical fibre in an optical fibre holder and immobilising the optical fibre with respect to the optical fibre holder for longitudinal, transverse and rotational movement of the optical fibre; placing the optical fibre holder onto a supporting base such that the optical fibre holder is immobilised with respect to the supporting base; clamping the optical fibre with a clamp movable with respect to the supporting base that when closed immobilises the optical fibre with respect to the supporting base for longitudinal and transverse movement of the optical fibre but allows rotation of the optical fibre about the longitudinal axis of the optical fibre; releasing the optical fibre from the optical fibre holder for movement with respect to the optical fibre holder; rotating the optical fibre about its longitudinal axis to achieve a desired rotational position of the optical fibre; immobilising the optical fibre in the desired rotational position with respect to the optical fibre holder; and releasing the optical fibre from the clamp.

The optical fibre may comprise an antiresonant hollow core optical fibre.

The method may further comprise observing an end-on view of an end of the optical fibre while rotating the optical fibre about its longitudinal axis.

The method may further comprise, between placing the optical fibre in the optical fibre holder and placing the optical fibre holder onto the supporting base, cleaving the optical fibre to provide a cleaved end proximate the optical fibre holder.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A device for positioning an optical fibre, the device comprising:
a supporting base;
a receiving region on the supporting base, the receiving region configured for receiving an optical fibre holder such that the optical fibre holder is immobilised with respect to the supporting base, the optical fibre holder for holding an optical fibre and comprising a clip operable between an open position in which an optical fibre held in the optical fibre holder is moveable with respect to the optical fibre holder and a closed position in which the held optical fibre is immobilised with respect to the optical fibre holder for longitudinal, rotational and transverse movement of the optical fibre, the supporting base configured to allow operation of the clip between the open position and the closed position when the optical fibre holder is received in the receiving region; and
first and second clamps,
wherein the first clamp is positioned to receive a free end of the optical fibre held in the optical fibre holder and is movably mounted on the supporting base to enable rotation about an axis coincident with a longitudinal axis of the optical fibre held in the optical fibre holder, the clamp configured for clamping an optical fibre held in an optical fibre holder received in the receiving region, and the clamp operable between an open position in which the optical fibre is not clamped with respect to the supporting base, and a closed position in which the optical fibre is clamped and immobilised with respect to the supporting base for longitudinal and transverse movement of the optical fibre but rotatable about the longitudinal axis of the optical fibre; and
the second clamp is positioned at a working end of the optical fibre held in the optical fibre holder and is movable between an open position and a closed position, wherein in the open position, the second clamp does not constrain the position of the optical fibre and, when in a closed position, the second clamp provides an aperture that is sized to receive the working end of the optical fibre so as to enable rotational movement of the fibre within the aperture.

2. A device according to claim 1, wherein the first clamp is configured to be rotatable with respect to the supporting base in order to rotate the optical fibre about the longitudinal axis of the optical fibre.

3. A device according to claim 2, wherein the first clamp is manually rotatable.

4. A device according to claim 2, wherein the first clamp is configured to rotate the optical fibre over a range limited to less than 360 degrees.

5. A device according to claim 4, wherein the first clamp is configured to rotate the optical fibre over a range limited to not more than 200 degrees.

6. A device according to claim 1, further comprising an observation apparatus mounted on the supporting base and configured to provide an end-on view of an end of an optical fibre held in the optical fibre holder and clamped by the first clamp.

7. A device according to claim 6, wherein the observation apparatus comprises a camera operable to capture images of the end-on view of the end of the optical fibre.

8. A device according to claim 7, wherein the observation apparatus further comprises an adjustable lens operable to focus the end-on view of the end of the optical fibre onto an image capture element of the camera.

9. A device according to claim 7, further comprising a display screen configured to display images of the end-on view of the end of the optical fibre captured by the camera.

10. A device according to claim 6, further comprising a light source operable to illuminate the end of the optical fibre viewable by the observation apparatus.

11. A device according to claim 10, wherein the light source is arranged to direct light onto a side of the optical fibre that said light is coupled into the optical fibre through the side of the optical fibre for propagation along the optical fibre and emission from the end of the optical fibre towards the observation apparatus.

12. A device according to claim 10, wherein the light source comprises one or more light-emitting diodes.

13. A device according to claim 10, wherein the light source is positioned to direct light onto a side of the optical fibre close to the end of the optical fibre.

14. A device according to claim 1, wherein the device is configured only for positioning optical fibres.

15. A device according to claim 1, wherein the device is further configured for processing optical fibres in addition to positioning optical fibres.

16. A device according to claim 15, wherein the device is configured for cleaving or splicing optical fibres in addition to positioning optical fibres.

17. A method of positioning an optical fibre, comprising:
placing an optical fibre in an optical fibre holder and immobilising the optical fibre with respect to the optical fibre holder for longitudinal, transverse and rotational movement of the optical fibre
placing the optical fibre holder onto a supporting base such that the optical fibre holder is immobilised with respect to the supporting base;
clamping the optical fibre with a first clamp movable with respect to the supporting base that when closed immobilises the optical fibre with respect to the supporting base for longitudinal and transverse movement of the optical fibre but allows rotation of the optical fibre about a longitudinal axis of the optical fibre and clamping the optical fibre with a second clamp movable between an open position and a closed position, wherein in the open position, the second clamp does not constrain the position of the optical fibre and, when in a closed position, the second clamp provides an aperture that is sized to receive a working end of the fibre so as to enable rotational movement of the optical fibre within the aperture, wherein the first clamp is positioned to receive a free end of the optical fibre and the second clamp is positioned at a working end of the optical fibre;
releasing the optical fibre from the optical fibre holder for movement with respect to the optical fibre holder;
rotating the optical fibre about its longitudinal axis to achieve a desired rotational position of the optical fibre;
immobilising the optical fibre in the desired rotational position with respect to the optical fibre holder; and
releasing the optical fibre from the first and second clamps.

18. A method according to claim 17, wherein the optical fibre comprises an antiresonant hollow core optical fibre.

19. A method according to claim 17, further comprising observing an end-on view of an end of the optical fibre while rotating the optical fibre about its longitudinal axis.

20. A method according to claim 17, further comprising, between placing the optical fibre in the optical fibre holder and placing the optical fibre holder onto the supporting base, cleaving the optical fibre to provide a cleaved end proximate the optical fibre holder.
